(19) United States
(12) Patent Application Publication
(10) Pub. No.: US 2019/0138830 A1
(43) Pub. Date: May 9, 2019

(54) Methods and Devices for Cognitive-based Image Data Analytics in Real Time Comprising Convolutional Neural Network

(71) Applicant: Irvine Sensors Corporation, Costa Mesa, CA (US)

(72) Inventors: James Justice, Huntington Beach, CA (US); David Ludwig, Irvine, CA (US); Virgilio Villacorta, Corona, CA (US); Omar Asadi, Garden Grove, CA (US); Fredrik Knutson, Irvine, CA (US); Mannchuoy Yam, Santa Ana, CA (US); Eric Weaver, Westminster, CA (US)

(73) Assignee: Irvine Sensors Corp., Costa Mesa, CA (US)

(21) Appl. No.: 16/026,160

(22) Filed: Jul. 3, 2018

Related U.S. Application Data
(63) Continuation-in-part of application No. 14/593,021, filed on Jan. 9, 2015, now Pat. No. 10,078,791.

(51) Int. Cl. G06K 9/00; G06K 9/46; H04N 5/247; G06K 9/62; G06N 3/08; G06N 3/04; G06N 7/00

(52) U.S. Cl. CPC G06K 9/00986; G06K 9/00744; G06K 9/4671; G06K 9/00718; H04N 5/247; G06K 2209/27; G06K 9/6228; G06N 3/08; G06N 3/04; G06N 7/005; G06K 2009/00738; G06K 9/00771

(57) ABSTRACT

A real time video analytic processor that uses a trained convolutional neural network that embodies algorithms and processing architectures that process a wide variety of sensor images in a fashion that emulates how the human visual path processes and interprets image content. Spatial, temporal, and color content of images are analyzed and the salient features of the images determined. These salient features are compared to the salient features of objects of user interest in order to detect, track, classify, and characterize the activities of the objects. Objects or activities of interest are annotated in the image streams and alerts of critical events are provided to the user. Instantiation of the cognitive processing can be accomplished on multi-FPGA and multi-GPU processing hardware.

### CROSS-REFERENCE TO RELATED APPLICATIONS

This application is a continuation-in-part (CIP) application and claims the benefit of U.S. patent application Ser. No. 14/593,021, filed on Jan. 9, 2015, entitled “Methods and Devices for Cognitive-based Image Data Analytics in Real Time”, now allowed, which in turn claims the benefit of U.S. Provisional Patent Application No. 61/925,615, filed on Jan. 9, 2014, entitled “Methods and Devices for Cognitive-based Image Data Analytics in Real Time” pursuant to 35 USC 119, each of which applications is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of image processing. More specifically, the invention relates to a system for the real time processing of massive sensor data streams of still imagery, video imagery, thermal imagery, multispectral imagery, hyperspectral imagery, Light Detection and Ranging (LIDAR) imagery and radar imagery.

Data analysts and surveillance system operators are not able to provide timely and effective results from these data streams using traditional analytical methods and tools. Attributes in the scene of interest are identified by the instant invention by running a plurality of processing algorithms on the image data which are in the form of convolutions on spatial, temporal, and color contents of images and which, with subsequent cross-modal correlations which emulate the image processing of the human visual path comprised of eye, retina, and cortex-based processing functions. The invention desirably produces object detections, object tracks, object classifications, and activity recognition and interpretations with negligible latencies.

### 2. Description of the Related Art

Military and commercial users have been developing and using imaging sensors for over forty years as a means to recognize targets based on the unique features of their signatures in electronic images. These sensors have high data output that is capable of quickly overwhelming the capacity of current communication links. Prior art attempts have partially solved this bottleneck problem through processing and reporting on a selected limited set of feature signatures and also recording all data for later post-mission analysis. For example, techniques such as Automatic Target Recognition (ATR) require extensive spatial models representing many possible views of targets to be detected and recognized. These techniques have never produced satisfactory probabilities of detection with acceptable levels of false detections. Other techniques based on a degree of modeling of neural systems exploit neural networks which must trained by analyzing extensive data sets to recognize targets or to recognize anomalous images. These techniques likewise have not performed well over the wide variety of imaging conditions that can occur. Modern learning methods, while making a contribution to the problem posed, have not produced acceptable timely and effective image data processing and exploitation.

It would be beneficial to integrate a sensor data processor for use in the sensor suite that significantly increases the timeliness and effectiveness of the data processing, exploitation, and dissemination.

The invention disclosed herein permits the optimization and operational deployment of a processor utilizing cognitive image processing principles which analyzes sensor outputs and annotates regions of potential threat or regions having pre-determined characteristics at the same rate as the sensor that is producing the data.

The disclosed invention enhances the performance of analysts by significantly reducing the time required for assessment and distribution of image processing results and improves the probability of potential threat and threat activity detection, prioritization, and operator/analyst alerting.

### BRIEF SUMMARY OF THE INVENTION

These and other aspects, embodiments, and features of the invention emulate how the human visual path processes large data volumes and identifies regions or target areas of salient interest, tracks these objects, classifies these objects, and interprets target object activities. The saliency technique herein classifies objects of interest by computing their features in space, time, and color and establishes the degree of correlation between the observed objects and the objects of interest. A key aspect of the invention is the computation of the saliency of observed objects.

These and various additional aspects, embodiments and advantages of the present invention will become immediately apparent to those of ordinary skill in the art upon review of the Detailed Description and the claims that follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 is a schematic illustration of the image processing architecture of the invention.

FIG. 2 is a schematic illustration of the entity-relationship diagram of the invention.

FIG. 3 is a schematic illustration of the data flow diagram of the invention.

FIG. 4 is a schematic illustration of the system processing pipeline overview of the invention.

FIG. 5 is a schematic illustration of the edge processor of the invention.

FIG. 6 is a schematic illustration of the edge processor algorithm flow of the invention.

FIG. 7 is a schematic illustration of the core processing flow of the invention.

FIG. 8 is an illustration of convolution and threshold of the invention.

FIG. 9 is an illustration of the Pyramidal Bayesian Network of the invention.

FIG. 10 is an alternative embodiment of an exemplar architecture of a system of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

### Detailed Description of Preferred Embodiments

In the Summary above and in this Detailed Description of Preferred Embodiments, reference is made to particular features (including method steps) of the invention. Where a particular feature is disclosed in the context of a particular aspect or embodiment of the invention, that feature can also be used, to the extent possible, in combination with and/or in the context of other particular aspects and embodiments of the invention, and in the invention generally.

The term “comprises” is used herein to mean that other features, ingredients, steps, etc. are optionally present. When reference is made herein to a method comprising two or more defined steps, the steps can be carried in any order or simultaneously (except where the context excludes that possibility), and the method can include one or more steps which are carried out before any of the defined steps, between two of the defined steps, or after all of the defined steps (except where the context excludes that possibility).

This invention may be embodied in many different forms and should not be construed as limited to the embodiments set forth herein. Rather, these embodiments are provided so that this disclosure will convey preferred embodiments of the invention to those skilled in the art.

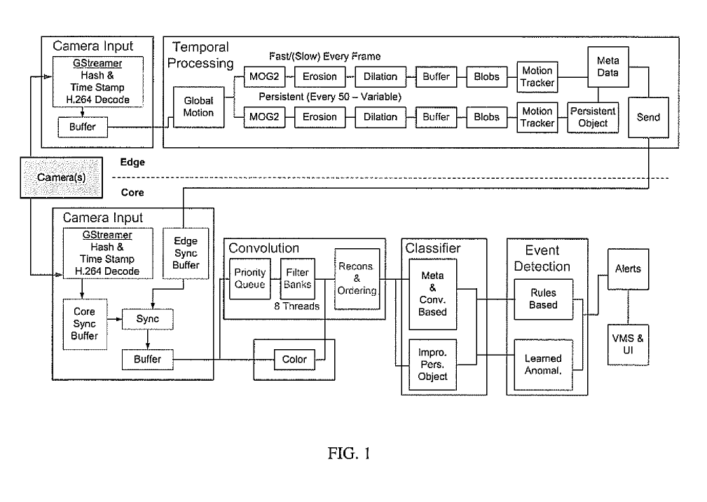

The invention's saliency processing approach, as illustrated in FIG. 1, relies on characterizing the spatial content (size, shape, orientation), temporal content, and color content of the imagery from multiple images or spectra and characterizing the data by determining locations where the content (spatial, temporal, color, spectral, and/or hyperspectral) matches that of known objects or events of interest and where locations show anomalous signatures when compared to adjacent locations. This processing is accomplished in parallel and at an accelerated rate.

Major elements of a preferred system of the invention may consist of one or a plurality of “edge” processors dedicated to analyzing the output image data of each camera or sensor and one or a plurality of “core” processors configured for analyzing data frames of interest from all system sensors, and edge processor metadata.

The various system elements cooperate to show cognitive video analytics to include spatio-temporal and color saliency, object classification and tracking within the data frames. An alternative embodiment of the system may comprise a modified core processor that subsumes all edge processing and core processing in a single unit.

Various embodiments of the system are enabled and may include, without limitation:
1. Direct Core Mode: Internet Protocol (IP) cameras connected directly to the core processor via Gigabit Ethernet (GigE) connections or via a network switch. Without edge processor analytic metadata, the core processor can support the analytic processing of up to, in one embodiment, eight High-Definition (HD) IP cameras.
2. Synergy Mode: Every IP camera is directly connected to an edge processor, which are all in turn connected to the core processor. This mode allows the core processor to support a security system with many cameras (e.g., 30-100), using edge data analytics to identify which cameras and even windows within those cameras require further image processing. That is, by analyzing the analytic metadata from all edge processors, the core processor may be configured to dynamically allocate processing resources to priority threats, uncompressing and processing at the appropriate resolution only threat identified video streams.
3. The system may be provided as a standalone system or integrated within a Video Management System (VMS) Application Program Interface (API).
4. The edge processors and the core processor may be provided in the same server unit or the edge and core processing functions of the disclosure may be distributed across dual server units. For example, an edge processor may be located with a particular camera and the associated camera output stream transmitted to a remote core processor along with the camera co-located edge processor outputs. In a further embodiment, the edge processing and the core processing may function as in the above example, but the functions accomplished in the same server unit. The image processor may be configured to host the edge and core processing functions on multiple or on single server platforms.
5. The target classification and labeling function of the invention relies on the spatial, temporal, and color processing of the camera image data to achieve object and object activity classification by using a variety of filtering techniques in each of the spatial, temporal, and color information domains. In a yet further embodiment, a modified architecture is disclosed that enables the use of pre-trained or continuously trained convolutional neural networks as an integrated element of the object and object activity classification process.
6. Any of the embodiments may comprise the use of one or more pre-trained or continuously trained convolutional neural networks in performing the classification function. The core processor may be configured to perform a salient feature extraction function by means of a convolution or trained convolutional neural network output, an object classification and an event detection from the core processor video stream and the analytic metadata output and the compressed video output based on a calculated correlation between an observed object and an object of interest.

The temporal processing module of the invention is responsible for determining motion-based salient features of the scene. According to FIG. 1, the temporal processing module may run before the spatial processing module on the same data set. In this configuration, the camera capture module is responsible for decoding the incoming video and feeding the main control logic with one frame at a time per camera. The annotation module is responsible for generating and drawing the bounding boxes on each frame before sending the frame off to the analyst's video management system to be displayed as a video for the analyst.

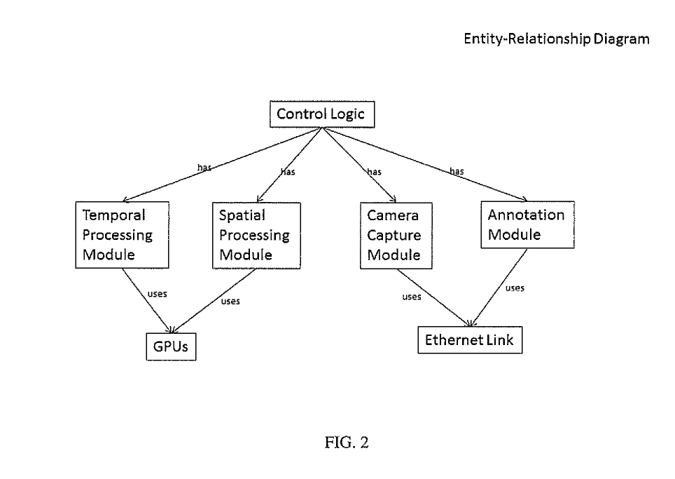

The system may be configured to be a single machine or a unit that processes video before outputting the data to the video management system. Note the central processing unit (CPU) is not depicted in the diagram of FIG. 2 as each module may be provided as a set of software instructions executed on a CPU. The graphics processing units (GPUs) are included because they are specialized hardware used to accelerate image processing to the point of analyzing video in approximately real time. The Ethernet link is included as the communication pathway with the cameras and VMS.

The Camera Capture module in FIG. 1 continuously reads in the video streams from each connected camera.

The Annotation module in FIG. 1 supplies the VMS with properly and consistently annotated frames.

The processor can be configured with different settings for the frame rate of the camera input, the frame rate of temporal processing, the number of cameras being processed in parallel, the expected size of objects in pixels for the spatial processing, and the type of objects to locate and annotate. The analyst may specify differing priorities for certain cameras in relation to the remainder of the cameras and may additionally specify priority regions within a camera's field of view. These features are illustrated in FIG. 1.

The Cognitive Processor approximates performance in real time with a processing time latency typically of no more than 500 msec.

The Camera Capture module detects and notifies the analyst if a video stream has been lost and is preferably configured to automatically attempt to restart the video stream and resume functionality with no other issues.

The Cognitive Processor can be configured to handle corrupted data without terminating the process.

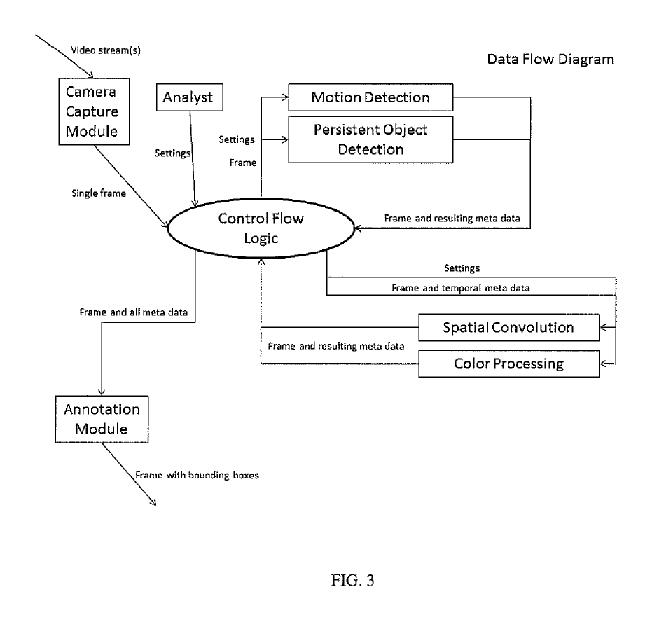

The motion detection and persistent object detection are both part of the overall temporal processing module of the system and are executed prior to the spatial convolution, color processing and object classification, as illustrated in FIG. 3.

As shown in FIG. 3, the frame and metadata travel from and return to the control flow logic rather than traveling directly from module to module in the event the analyst elects not to run any of the modules. Default operation involves executing both modules prior to annotation.

Multiple configurations of the system are enabled but the underlying architecture remains generally the same in each. A difference between the two is the hardware on which the system runs. An increased number of GPUs or the use of high performance elements gives the ability to process many HD cameras in parallel.

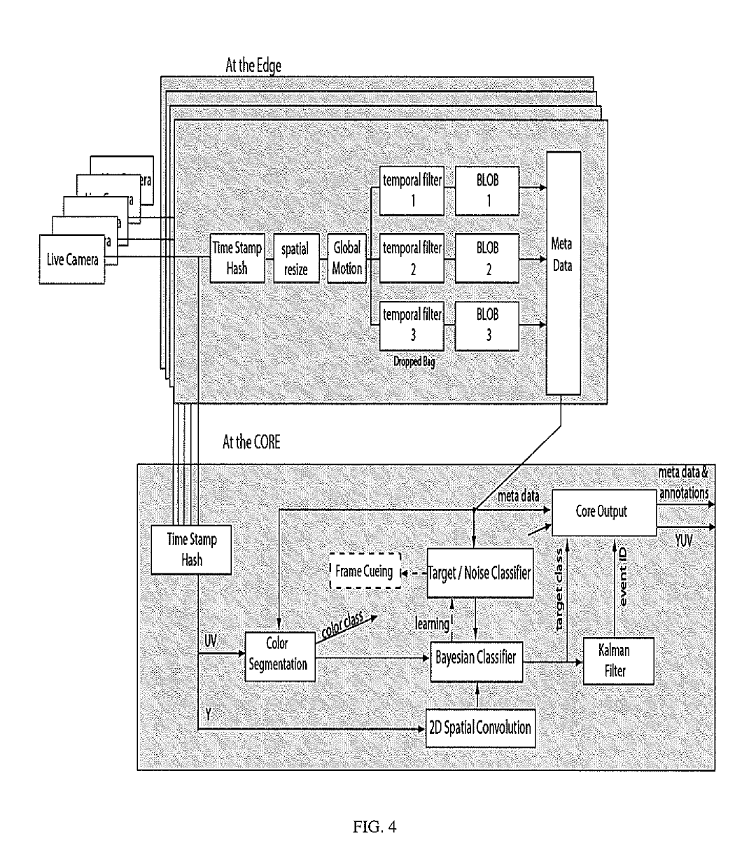

The core processor, edge processor, and IP cameras communicate in the system via a hash synchronization mechanism, as illustrated in FIG. 4. The method of grabbing frames from the camera(s) used due to edge hardware does not offer synchronization between multiple streams—each stream has its own frame identification sequence number that is independent of the other streams' sequence numbers. The hash synchronization mechanism allows the disclosed system to process the same video stream on separate processors without requiring the camera to generate coordination or organization information.

The core processor and the edge processor each receive a separate, independent video stream from the same IP camera, as shown in FIG. 4. This leads to the synchronization issue described above.

The invention herein takes advantage of the fact the frames themselves are identical at the pixel level and thus the frames can be mapped to each other based on that comparison.

The bandwidth and processing power requirements of sending and comparing entire frames are prohibitively expensive in the context of the invention. This issue is addressed by hashing the frame at both the edge and the core processors.

The fact that even a slight change (a single bit difference) in the input to a hash function results in a vastly different hash output ensures a unique identifier for each frame and permits synchronizing the video streams to the edge and the core processors.

The invention hashes frames until the edge processor receives confirmation from the core processor that the streams have been synchronized.

At this point, the timestamp differences between the edge processor's stream and the core processor's stream are known, and the system discontinues hashing every frame and returns to normal operation, easing the system processing requirements.

The edge processor of the system pre-conditions video data for analysis by the core processor. These steps include pre-processing functions, baseline analytics, and post-processing compression.

The edge processor enhances the functionality of the core processor and reformats the camera video into a standard compressed format that the core processor requires.

Pre-processing functions in the invention may comprise:
1. Automatic contrast adjustment or automated gain control (AGC)
2. Histogram equalization
3. Color Bayer pattern demosaicing
4. Image stabilization

Analytic functions in the invention may include:
1. Motion detection utilizing uncompressed data
2. Tracking window identification
3. Feature-based characterization of tracked windows contents

Analytic metadata output may comprise the following:
1. A bounding box window of moving targets
2. Window unique ID
3. Speed and direction of travel metrics (expressed in pixels per frame)
4. Shape based salient object features—to include aspect ratio, area, and perimeter—associated with each object
5. Intensity and color-based salient features in the cases when color processing is handled on edge processors

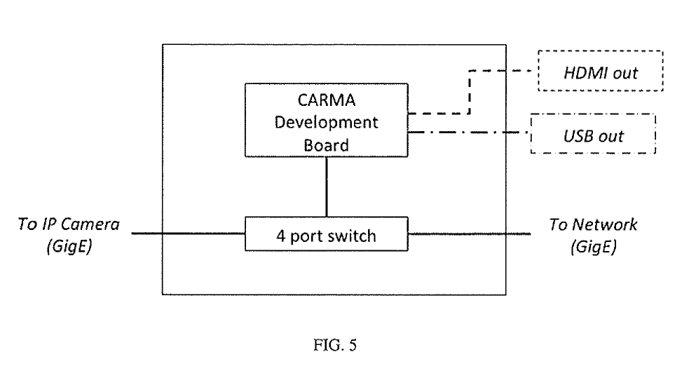

The edge processor of the invention may be configured to support a GigE input (up to 1000 Mb per second, bidirectional), as shown in FIG. 5.

The edge processor supports a GigE output to allow a connection to a network switch, as illustrated in FIG. 5, and has two basic output modes, depending on whether or not the output is to be further analyzed by the core processor or displayed on a standard workstation executing appropriate software.

The edge processor outputs analytic metadata and compressed video.

The output bandwidth of each edge processor is programmable and is primarily limited by network capacity and the input capacity of the core processor.

An exemplar power specification of a preferred embodiment is 12V DC, 25 watts max. This specification can be met using Power over Ethernet (PoE) technology meeting the IEEE standard.

Use of PoE technology for the edge processor eliminates the need for a battery or co-locating near a power outlet.

The edge processor of the invention may comprises a Development Board (Dev BD) and a mobile graphics processing unit, illustrated in FIG. 5, and is designed to provide basic spatio-temporal saliency analytics.

The edge processor includes a compact network switch as shown in FIG. 5, to permit the network connection between the Dev BD and the camera to be isolated from the remainder of the security network. This allows high bit-rate video to be sent to the edge processor without bogging down the remainder of the network. The housing includes HDMI and USB port extensions from the Dev BD.

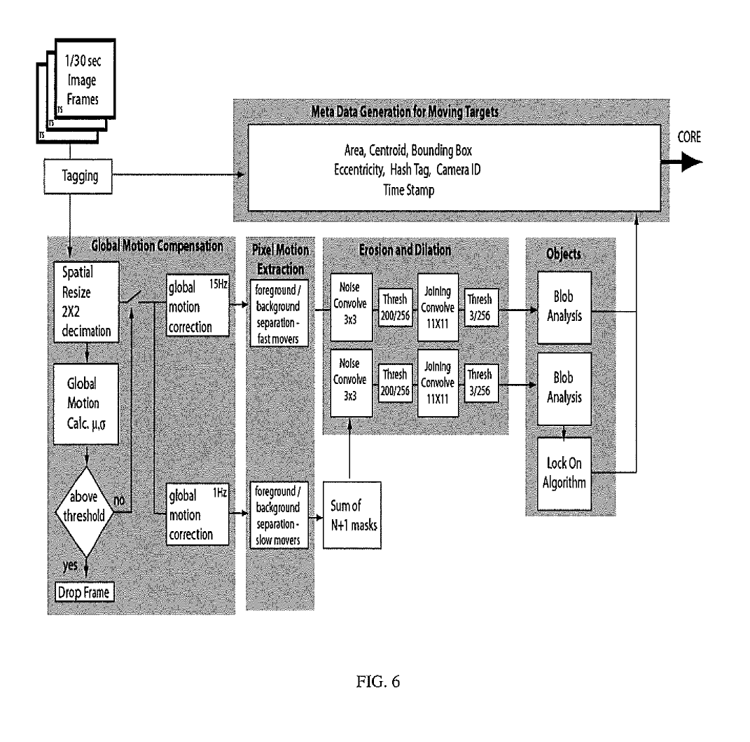

A single processing stream is defined as the complete set of mathematical operations required to convert a video sequence of image frames into a sequence of edge processor system windows. A number of processing streams are run simultaneously on the edge processor device, with each running at a different frame rate as in FIG. 6.

The pre-processing flow may include the following functions:
1. H.264 decoding
2. Image stabilization
3. Spatial re-sizing
   The built-in hardware has decoders for H.264. The other two processes may be run on the CPU using open-source library function calls.

The spatial re-size in FIG. 6 reduces the image to a quarter of the input size using “nearest neighbor” interpolation though any spatial re-size may be selected by the user.

Motion-based salient features are detected on the edge processor utilizing a Gaussian mixture model for background subtraction, demonstrated in FIG. 6. This includes a foreground binary mask to remove noise. A morphological operation is included to connect nearby components into larger objects.

The system analyzes this modified foreground mask to find larger objects. Location information is output for one or more each of these objects.

The background subtraction function utilizes default input parameters, with shadow detection built into the Gaussian mixture model operating on color imagery.

A morphological erosion noise removal algorithm is implemented and utilizes a convolution with an averaging filter, followed by pixel-wise comparison with a threshold as illustrated in FIG. 6.

This erosion operation takes advantage of GPU-acceleration. The threshold may be a reasonably large fraction of the kernel area. Only convolution outputs exceeding the threshold are kept as in FIG. 6.

A morphological dilation operation follows the erosion and is used to connect smaller clusters into larger objects. This can be accomplished using a convolution with an averaging kernel and keeping any non-zero mask pixel, as shown in FIG. 6.

The blob analysis output of the morphologically transformed binary mask may be analyzed to output the larger objects as system alerts as illustrated in FIG. 6. This function marks the end of GPU acceleration for temporal processing and may be run on the CPU.

This output function may be configured in the system and is used to detect global scene motion. If the output number exceeds a threshold, then a “global motion” flag is sent rather than an alert on individual moving windows.

Size-based object filters at the edge are utilized to remove noise related false alarms.

To remove flickering foreground objects and keep only those maintaining a constant motion, the system may be configured to keep a short memory of past alerts. These alerts can remain hidden unless they are detected consistently in the past history of events.

Object centroid values are calculated utilizing moments of inertia corresponding to each object.

A Kalman-filter-based tracking algorithm is used to assign unique identifications to the same object across multiple frames. This tracking mechanism is described below.

The core processor may be a GPU cluster on a server rack. This rack may have preferably dual CPUs on the motherboard and large amounts of RAM.

The core processor hardware preferably includes configuration of hard drives for local archive.

A modified core processor may subsume the edge processing on the separate Dev BD.

The core processor of the invention produces a number of analytics related to intrusion detection, threat detection, and forensic analysis for perimeter surveillance utilizing IP-based security cameras.

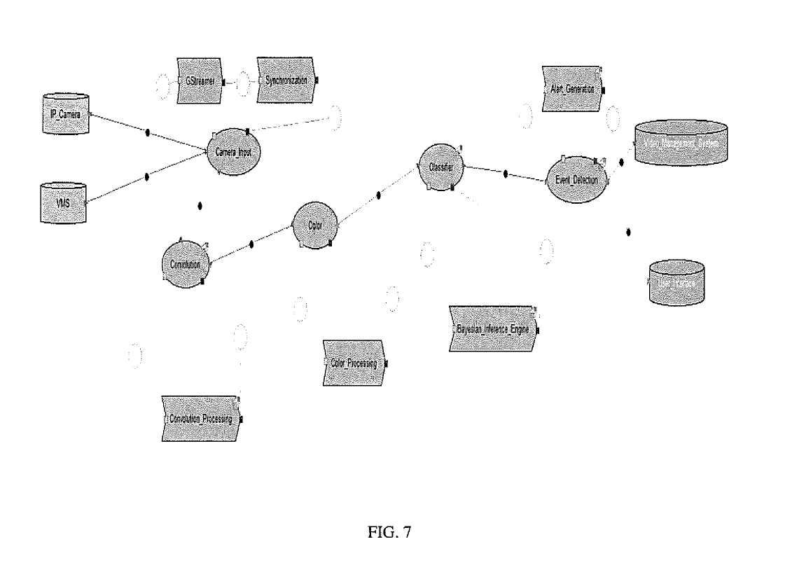

The functional processes performed by the core processor of the invention include video decoding and decompression as well as image or video reformatting, preprocessing, saliency of spatial and temporal channels, color selection, hyperspectral anomaly detection and spectral feature match, cross-modal correlation, geo-location and registration, and motion detection and recognition of objects, humans and vehicles, illustrated in FIG. 7.

The core processor may be comprised of GigE ports for direct connection either to multiple high resolution IP cameras or to a network switch.

Camera types supported by the system may include color and monochrome visible, near infrared, short wave infrared, mid wave infrared, long wave infrared, far infrared, and hyperspectral cameras.

The core processor output specification desirably matches the integration specifications of VMS.

Other inputs are a rules-set for the recognition engine, which are initially required for a new system but can be phased out as the cognitive rules are learned and adopted.

Mission profiles may also be set up using the initial rule sets that are adaptively learned based on a number of parameters: proximity-based, events-based, behavior-based, and mission-based.

The output of the core processor includes the compressed video output for archiving and storage and the core processing analytics as shown in FIG. 7.

The output of the analytic metadata matches that of VMS specifications to allow integration into these systems as shown in FIG. 7.

This output of analytic metadata integration includes the use of the core processor analytics in forensic analysis and in immediate priority threat alerts as shown in FIG. 7.

Processing at the core comprises color-based salient feature extraction, metadata classification and priority queue, orientation-based saliency extraction via spatial convolution, object classifier, trackers, and persistent object detection as shown in FIG. 7.

Core processing metadata output includes event ID, size, location, timestamp, camera ID, object class, object velocity, object acceleration, color anomaly flag, and color classification, illustrated in FIG. 7.

The cluster outputs are determined for the sampled frame and are matched to the nearest neighbor from the previously determined color clusters using a Hungarian matching algorithm as illustrated in FIG. 7.

At the full frame rate, each pixel is matched to the nearest color cluster value as illustrated in FIG. 7.

Distance on a per-pixel basis to the nearest matching cluster value is calculated. If this exceeds a predetermined threshold, and if the number of grouped anomalies exceeds another predetermined threshold, then the color anomaly flag is annotated for that region as illustrated in FIG. 7.

For objects detected in the edge processing, pixels within the object bounding box region are ranked based on color cluster value. Color-based salient features consist of a fraction of bounding box pixels containing a given cluster value.

Valid metadata output for edge annotated object A may be the following: 0, 0.2, 0.1, 0, 0, 0, 0.5, 0.2. This means that for an eight-color cluster, 20% of the object's pixels were of color type 2, 10% of color type 3, 50% of color type 7, 20% of color type 8, and no pixels of the other colors.

A priority queue is utilized to determine which frames must be processed immediately for spatial information based on temporal processing data. This is used to keep the spatial convolution engine constantly running in a multi-camera system in which the camera input can outstrip the processing capacity of the core GPUs. The priority queue loads only important frames based on the edge processing determination as illustrated in FIG. 7.

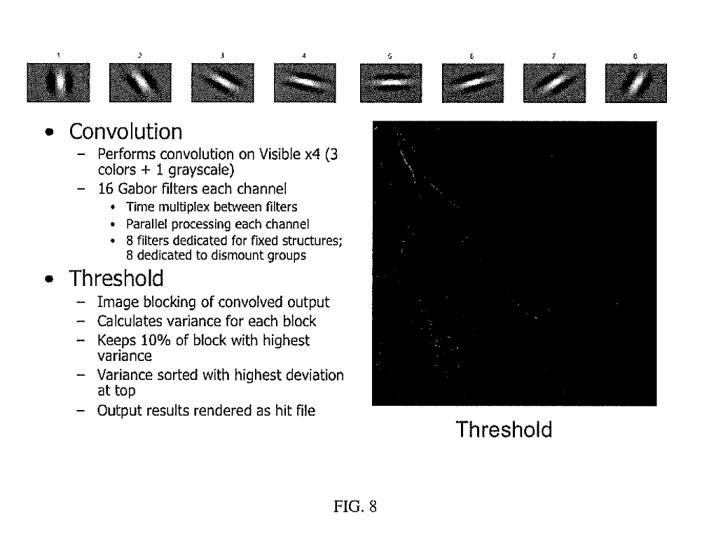

The spatial convolution filter banks have properties for image analysis such as selectivity to orientation, scale sand spatial frequency, and being especially suited to characterize image texture as illustrated in FIG. 8.

Use of a filter bank instantiates a virtual hyper-column creating a set of parallel output channels each tuned to extract a specific spatial orientation saliency, as illustrated in FIG. 8.

The filter bank in the preferred embodiment is applied to each raw color channel and to the grayscale image, though any number of filter algorithms and image processing algorithms are contemplated as within the scope of the invention.

Convolution kernels, illustrated in FIG. 8, are spread over multiple GPUs with one kernel per GPU in a preferred embodiment.

The GPUs all require the same input and each GPU is configured to copy the input to its own local memory to run the convolutions in parallel.

The outputs of every spatial convolution over the object windows are combined into local histograms of preferred filter orientations at the pixel. This histogram is weighted by the convolution difference between the maximum filter magnitude and the minimum filter magnitude at every given pixel.

The invention exploits the vector math abilities of the GPU processors to run a convolution on multiple images at the same time.

The GPU runs arithmetic operations on multiple values in one instruction, so it is efficient to incorporate multiple images into one variable to minimize processing time.

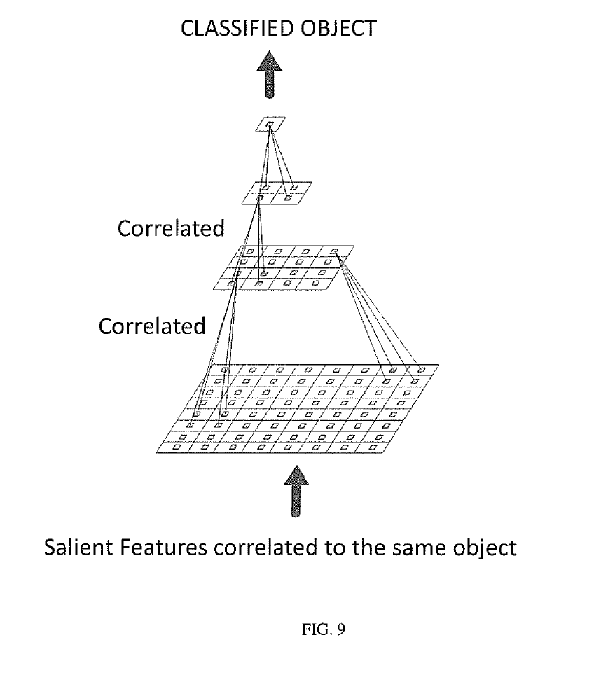

The object classifier makes use of the pyramid graph Bayesian Network (PBN) (See FIG. 9). The PBN has a property that the nodes are hierarchical belonging to a level in the pyramid with the lowest (base) level observed.

Each pyramid level may be a rectangular grid.

The hierarchical nodes have dependencies on axis-aligned neighbors in the same level or adjacent nodes in the parent level. This type of network works with recognition and situation assessment.

The bottom level adjacent node corresponds to the collateral salient information from different sources. This includes data derived from shape and motion properties determined in edge processing, color characteristic properties, and spatial convolution properties determined at the core.

The PBN maintains prior and posterior probability estimates of optimal parameter sets describing a behavior. The PBN contains a number of nodes whose parameters specify a transformation on the incoming information assuming that a behavior is continuously parameterized.

PBNs are employed in the invention to design independent agents because they have formal probabilistic semantics.

The PBNs used in the invention are composed of nodes and arrows. The structure specifies how the nodes are connected.

Each node represents a variable (or source of information) that can take on many discrete or continuous states. In the invention, all PBN nodes may have discrete states.

An arrow connecting two nodes indicates a dependent relationship between the two nodes, meaning that a state can influence the state of the connected node.

How much influence the dependent relationship has on the nodes may be specified in one or more conditional probability tables (CPTs), which are also called parameters.

The PBN structure can be formed using a combination of expert knowledge and training data.

In the invention, each salient feature (spatial, temporal, color, and shape-based) serves as a node, with values in each salient feature binned to a fixed number of states.

The classifier illustrated in FIG. 7 operates to classify edge-determined windows into a number of classes, which includes classification of parts as well as whole figures. These classes are outputs of the core processor as illustrated in FIG. 7.

Tracking is applied to classified objects as illustrated in FIG. 7.

For objects in a given class, objects are matched from one frame to another utilizing a Hungarian matching algorithm as illustrated in FIG. 7.

The predicted position of each object from the previous frame is matched to the nearest object in the current frame, and the Hungarian algorithm is used to ensure the optimal match is made for the overall frame as illustrated in FIG. 7.

In order to predict the next object position, a Kalman filter predictor is used, illustrated in FIG. 7. Tracking IDs determined from this module are an output of the core processor as illustrated in FIG. 7.

Persistent objects, newly appearing objects that remain static over a long period of time (a dropped bag, for example), are detected on a slowly sampled video stream using the edge (motion) processing algorithms as shown in FIG. 6.

The invention constructs a binary image of the motion processing, where a pixel is turned on if motion is detected and turned off if no motion is detected.

The invention sums the binary images from the last several iterations of this slow sampling motion process. If any pixels from this sum exceed a certain threshold, the invention determines that a persistent object has been detected.

The invention erodes and dilates the resulting thresholded frame to remove noise as in normal motion processing.

The invention utilizes multiple looks of the same object(s) in different frames to improve accuracy and remove anomalous mischaracterizations of object class, type, color, size, speed and direction of travel.

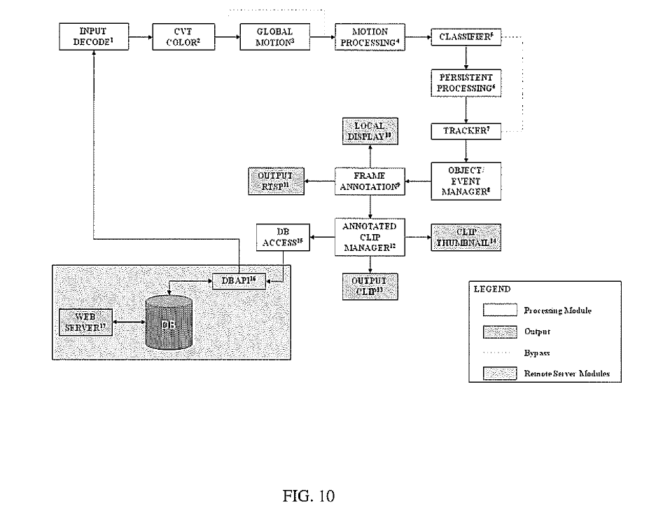

FIG. 10 illustrates an alternative preferred embodiment of the system architecture of the invention. Each processing module operates simultaneously running threads that pass metadata and frame data contained in the same buffer to each other in the manner shown. Such a structure allows the data pipeline to be rate-limited by the individual modules having the longest processing time, rather than by the accumulated processing time of all modules.

The input decoder functions is the starting module and decodes the input that is received as compressed video data streams as well as saved video files.

The CVT color block converts the decoded video frames received from the input decoder into color formats required for later processes and also uploads required frame data onto the graphics processing unit (GPU).

The global motion block detects and adjusts the current frame for global shifts in camera position.

The motion processing block detects moving objects within the frame.

The classifier block detects objects of a known class type (e.g., “person”, “car”, “truck”, “bike”) within the frame. The classifier block may employ a selection of filtering techniques in the spatial, color, and temporal domain that may include use of Higher Order Gaussian and/or Gabor filtering, Reichart and/or difference temporal filtering, RGB color filtering, use of Baysian Inference Modeling, and/or the use of pre-trained or continuously trained convolutional neural networks.

The persistent processing block detects objects introduced into the scene that have become static (i.e., “left behind objects”).

The tracker block uses object type, detected location and velocity to associate the same object(s) with the same unique identifier over time.

The object/event manager block applies predefined rules to include detected object types, motion types, direction of travel, tripwires, and keep out zones.

The frame annotation block labels metadata onto the frame.

The local display block is a feature that opens a separate console to display annotated video output on the local machine and is optional for uses such as debugging.

The output RTSP block generates an output annotated video stream which can be displayed on other workstations on the same network via a media player.

With respect to the output clip, for events entered into the database, a short video clip of the highlighted event is also generated and linked to in the database event metadata.

With respect to the clip thumbnail block, the first frame of the output video clip is saved as an image and linked to in the database event metadata.

The DB access block is a communication module between the system software and the database API which may be resident on another server on the network.

The DB API software allows interaction between the database and system software.

The web server runs the user interface that allows workstations that are on the same network as the overall system to setup, configure, control, display and analyze system cameras and events.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

What is claimed:

1. A real time video analytic image processor comprising:
an imaging sensor configured for capturing and outputting a sequence of image frames to define a video stream;
an edge processor configured to receive the video stream to define an edge processor video stream;
a core processor configured to receive the video stream to define a core processor video stream;
the edge processor and the core processor comprising a hash synchronization function whereby the image frames are synchronized to the edge processor and the core processor using a unique hash identifier;
the edge processor configured to perform a video stream pre-processing function, an analytic function, an analytic metadata output function and a post-processing video compression function to provide an analytic metadata output and a compressed video output;
the core processor configured to receive the analytic metadata output and the compressed video output from the edge processor; and;
the core processor configured to perform a salient feature extraction function by means of a convolution, trained convolutional neural network or a trained output, an object classification and an event detection from the core processor video stream, the analytic metadata output and the compressed video output based on a correlation between an observed object and an object of interest.

2. The image processor of claim 1 comprising a plurality of imaging sensors, each imaging sensor configured for capturing and outputting a sequence of image frames to define a plurality of independent video streams.

3. The image processor of claim 1 configured for processing still imagery.

4. The image processor of claim 1 configured for processing high definition (HD) video or full motion video (FMV) imagery.

5. The image processor of claim 1 configured for processing thermal imagery.

6. The image processor of claim 1 configured for processing multispectral imagery.

7. The image processor of claim 1 configured for processing hyperspectral imagery.

8. The image processor of claim 1 configured for processing LIDAR imagery.

9. The image processor of claim 1 configured for processing radar imagery including synthetic aperture array (SAR) and ground moving target indicator (GMTI) imagery.

10. The image processor of claim 1 wherein the salient feature extraction, classification and annotation function is performed in real time at the same rate as the sensor is producing image data.

11. The image processor of claim 1 wherein the host the edge processor and core processing functions are hosted on a single server platform.

11. The image processor of claim 1 wherein the host the edge processor and core processing functions are hosted on multiple server platforms.

12. An image processor comprising:
an imaging sensor configured outputting a sequence of image frames to define a video stream;
an edge processor configured to receive the video stream to define an edge processor video stream;
a core processor configured to receive the video stream to define a core processor video stream;
the edge processor and the core processor comprising a hash synchronization function whereby the image frames are synchronized to the edge processor and the core processor using a unique hash identifier;
the edge processor configured to perform at least one of a video stream pre-processing function, an analytic function, an analytic metadata output function and a post-processing video compression function to provide an analytic metadata output and a compressed video output;
the core processor configured to receive the analytic metadata output and the compressed video output from the edge processor; and;
the core processor configured to perform a salient feature extraction function by means of at least one of a convolution or a trained output, an object classification and an event detection from the core processor video stream, the analytic metadata output and the compressed video output based on a correlation between an observed object and an object of interest.
